(19) United States
(12) Patent Application Publication
(10) Pub. No.: US 2013/0307401 A1
(43) Pub. Date: Nov. 21, 2013

(54) LIGHT-EMITTING DEVICE PACKAGE

(71) Applicants: Takuma Hitomi, Kyoto (JP); Masashi Kubota, Tokyo (JP)

(72) Inventors: Takuma Hitomi, Kyoto (JP); Masashi Kubota, Tokyo (JP)

(73) Assignees: SANYO TUNER INDUSTRIES CO., LTD., Daito-shi, Osaka (JP); SANYO ELECTRIC CO., LTD., Moriguchi-shi, Osaka (JP)

(21) Appl. No.: 13/982,657

(22) PCT Filed: Oct. 17, 2011
(86) PCT No.: PCT/JP2011/073806

§ 371 Date: Jul. 30, 2013

(30) Foreign Application Priority Data
Jan. 31, 2011 (JP) 2011-017751

(51) Int. Cl. H05B 33/02

(52) U.S. Cl. CPC H05B 33/02
USPC 313/113

(57) ABSTRACT

Provided is a light-emitting device package having a high reflectance and strength. In a light-emitting device package (10) containing: a glass ceramic (21) as a major component; and a high refractive index material (23) having a higher refractive index than the glass ceramic, and being for housing a light-emitting element (2) therein and reflecting light emitted from the light-emitting element (2) toward a predetermined direction, the high refractive index material (23) is a silicate compound.

### TECHNICAL FIELD

The present invention relates to a light-emitting device package for housing a light-emitting element therein.

### BACKGROUND ART

A conventional light-emitting device is disclosed in Patent Literature 1. The light-emitting device includes a package for housing therein a light-emitting element such as an LED. The package is formed for example from a sintered body that contains, as a major component, a glass ceramic made from borosilicate glass and alumina. The sintered body contains a high refractive index material, such as zirconia (ZrO₂) and zinc oxide (ZnO), having a higher refractive index than the glass ceramic. The sintered body for forming the package is obtained by mixing powders of the high refractive index material and raw materials for the glass ceramic together, and firing the mixture after the mixture is formed into a predetermined shape.

The package includes: a base on which wire conductors are formed; and an annular reflective member adhesively fixed onto the base. The light-emitting element is housed inside the reflective member, and connected to the wire conductors by wire bonding or the like. The reflective member is filled with a sealing material made of a transparent resin, so that the light-emitting element is sealed.

Light emitted from the light-emitting element is guided by the sealing material, reflected off a surface of the base and an inner wall of the reflective member, and directed upwards. As a result, light is emitted from an upper surface of the light-emitting device over a predetermined range.

Since the package contains the high refractive index material, the amount of light reflected at the interface between particles of the glass ceramic and particles of the high refractive index material is increased by the difference in the refractive index therebetween. This can result in improvements in reflectance of the package and luminous efficiency of the light-emitting device.

### CITATION LIST

### Patent Literature

### [Patent Literature 1]

Japanese Patent Application Publication No. 2009-164311 (pages 8 to 26, FIG. 3)

### SUMMARY OF INVENTION

### Technical Problem

According to the conventional light-emitting device package described above, however, the high refractive index material chemically reacts with surrounding glass components during firing of the package, leading to a change in its quality. For example, when zinc oxide is used as the high refractive index material, gahnite is formed during firing. This causes a problem of reducing the refractive index of the high refractive index material, leading to a decrease in reflectance of the package.

In contrast, when zirconia, which is less likely to chemically react with glass, is used as the high refractive index material, reflectance of the package can be maintained at a high level. However, since bond strength at the interface between the glass ceramic and the high refractive index material is low, the strength of the package might be reduced.

The present invention aims to provide a light-emitting device package having a high reflectance and strength.

### Solution to Problem

In order to achieve the above-mentioned aim, the present invention is a light-emitting device package for housing a light-emitting element therein and reflecting light emitted from the light-emitting element toward a predetermined direction, the light-emitting device package comprising a sintered body that contains: a glass ceramic as a major component; and a high refractive index material having a higher refractive index than the glass ceramic, wherein the high refractive index material is a silicate compound.

According to this structure, the light-emitting device package is obtained by firing a mixture of the silicate compound as raw materials for the high refractive index material and raw materials for the glass ceramic, after the mixture is formed into a predetermined shape. As a result, the light-emitting device package comprising the sintered body that contains: the glass ceramic as a major component; and the high refractive index material is formed.

In the light-emitting device package having the above-mentioned structure, the silicate compound is zircon.

In the light-emitting device package having the above-mentioned structure, zircon content is 5 wt % or more.

In the light-emitting device package having the above-mentioned structure, the zircon content is 10 wt % or more.

In the light-emitting device package having the above-mentioned structure, the zircon content is 40 wt % or less.

### Advantageous Effects of Invention

According to the present invention, since a light-emitting device package comprises a sintered body that contains a glass ceramic and a silicate compound contained as the high refractive index material in the glass ceramic, a light-emitting device package having a high reflectance and strength can be obtained.

### BRIEF DESCRIPTION OF DRAWINGS

FIG. 1 is a perspective view showing a light-emitting device in an embodiment of the present invention.

FIG. 2 is a front cross-sectional view showing the light-emitting device in the embodiment of the present invention.

FIG. 3 is a conceptual diagram showing an internal cross-section of a light-emitting device package in the embodiment of the present invention.

FIG. 4 is a process chart showing a process of manufacturing the light-emitting device package in the embodiment of the present invention.

FIG. 5 shows a relationship between reflectance of the light-emitting device package in the embodiment of the present invention and a compounding ratio of a high refractive index material.

FIG. 6 shows a relationship between transverse rupture strength (bending strength) of the light-emitting device package in the embodiment of the present invention and the compounding ratio of the high refractive material.

FIG. 7 shows a relationship between reflectance of the light-emitting device package in the embodiment of the present invention and wavelength.

### DESCRIPTION OF EMBODIMENTS

The following describes an embodiment of the present invention with reference to the drawings. FIG. 1 is a perspective view showing a light-emitting device in one embodiment. A light-emitting device 1 includes a package (housing) 10 comprising a sintered body that contains a glass ceramic 21 as a major component (see FIG. 3). In an upper surface of the package 10, a recess 10a is formed to house therein a light-emitting element 2 composed of an LED. Light emitted from the light-emitting element 2 is reflected off a peripheral wall and a bottom wall of the recess 10a, and directed toward a predetermined direction.

The recess 10a is filled with a sealing material 3 for sealing the light-emitting element 2. The sealing material 3 includes a transparent resin and particles of phosphors dispersed in the transparent resin to convert wavelength of light. In the present embodiment, the light-emitting element 2 emits blue light, and the phosphors convert wavelength of blue light into wavelength of yellow light. Other types of phosphors and light-emitting elements may be used instead.

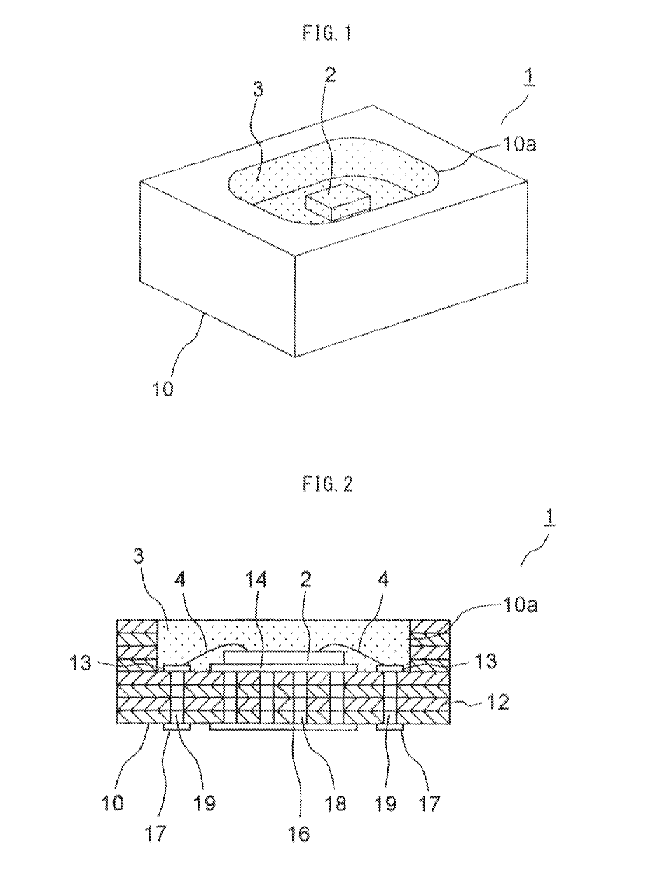

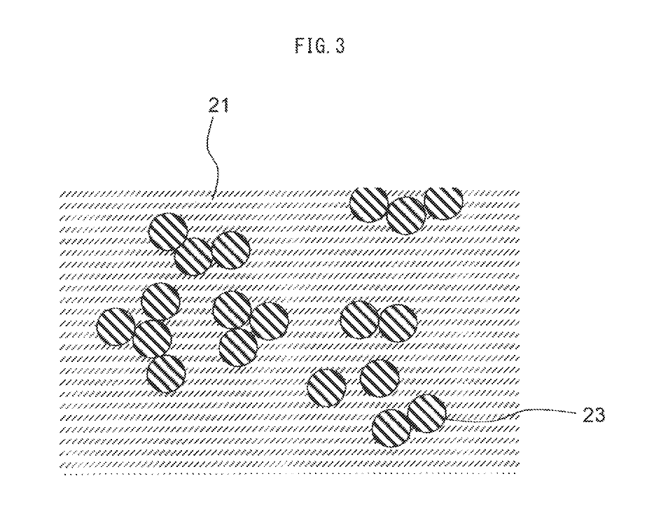

FIG. 2 is a front cross-sectional view of the light-emitting device 1. The package 10 is formed by laminating a plurality of ceramic sheets 12. A through hole for forming the recess 10a is formed in each of one or more ceramic sheets 12 constituting an upper portion of the package 10. Heat dissipation vias 18 and electrode vias 19 are formed in one or more ceramic sheets 12 constituting a lower portion of the package 10 so as to pass through the lower portion of the package 10. The heat dissipation vias 18 and the electrode vias 19 are each filled with a conductive material. A heat transfer member 14 is formed over upper surfaces of the heat dissipation vias 18, and a heat dissipation member 16 is formed over lower surfaces of the heat dissipation vias 18.

The light-emitting element 2 is fixed onto the heat transfer member 14 by adhesion or the like at the bottom of the recess 10a. Heat generated by the light-emitting element 2 is transferred from the heat transfer member 14 to the heat dissipation member 16 through the heat dissipation vias 18, and dissipated by the heat dissipation member 16. A terminal 13 and an electrode 17 are formed respectively on an upper surface and a lower surface of each of the electrode vias 19. The terminal 13 and the electrode 17 are electrically connected to each other through the electrode via 19. The light-emitting element 2 is connected to each of the terminals 13 through a wire 4 by wire bonding.

FIG. 3 is a conceptual diagram showing an internal cross-section of the package 10. The package 10, whose major component is the glass ceramic 21, contains particles of a high refractive index material 23 having a higher refractive index than the glass ceramic 21.

Examples of the glass ceramic 21 are a glass ceramic containing borosilicate glass and alumina (having a refractive index of approximately 1.5) and a glass ceramic containing soda lime glass and alumina (having a refractive index of approximately 1.5). The glass content of the glass ceramic 21 is 35 wt % to 60 wt %, and the ceramic content of the glass ceramic 21 is 40 wt % to 60 wt %. The refractive index of the glass ceramic 21 can be increased by adding titanium oxide and/or tantalum oxide to borosilicate glass.

The high refractive index material 23 is a silicate compound. As the silicate compound, manganese silicate (Mn₂SiO₄), calcium silicate (CaSiO₃), zircon (ZrSiO₄), and the like can be used.

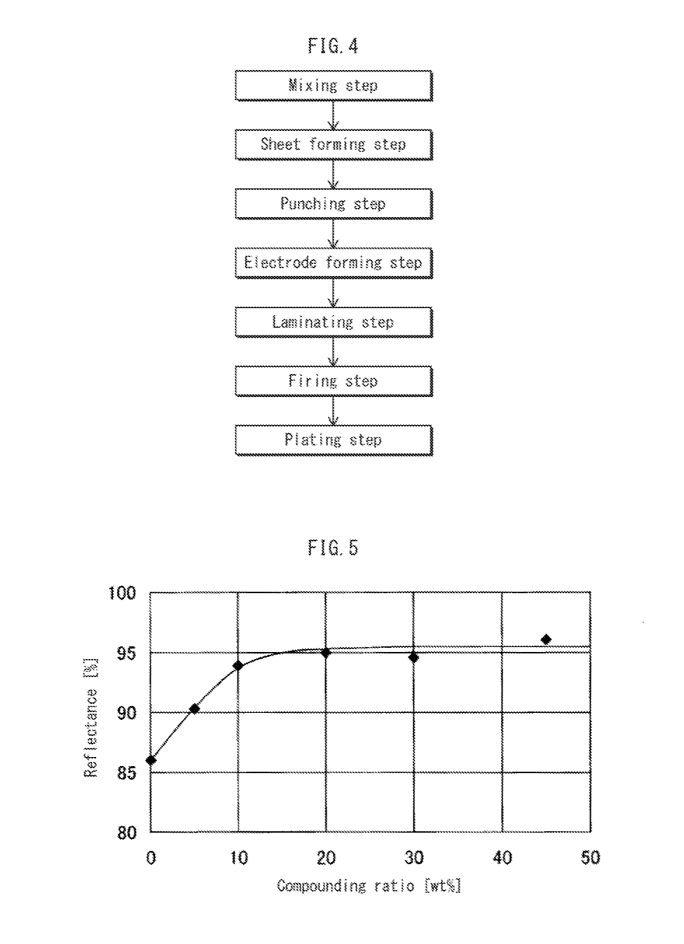

FIG. 4 is a process chart showing a process of manufacturing the package 10. In a mixing step, raw materials for the glass ceramic 21 and raw materials for the high refractive index material 23 are mixed together to generate a mixture. The raw materials for the glass ceramic 21 and the raw materials for the high refractive index material 23 are formed for example from powders each having a predetermined particle diameter.

In a sheet forming step, the mixture generated in the mixing step is formed into the shape of a sheet having a thickness of 0.1 mm, for example, by a method such as a doctor blade method to form materials for the ceramic sheets 12. In a punching step, through holes for forming the recess 10a, the heat dissipation vias 18, and the electrode vias 19 are punched in the materials for the ceramic sheets 12. In an electrode forming step, conductors for forming the terminal 13, the electrode 17, the heat transfer member 14, and the heat dissipation member 16 are formed on the materials for the ceramic sheets 12 by printing.

In a laminating step, the materials for the ceramic sheets 12 are laminated by temporarily being fixed to one another by low-temperature heat and pressure. As a result, a material for the package 10 is formed. In a firing step, the material for the package 10 is fired in a furnace at approximately 900° C. to form the package 10 comprising a sintered body.

In a plating step, the terminal 13, the electrode 17, the heat transfer member 14, and the heat dissipation member 16 are plated. As a result, the package 10 is obtained.

In the light-emitting device 1 having the above-mentioned structure, blue light emitted from the light-emitting element 2 is guided by the sealing material 3, and, when the blue light reaches the phosphors, wavelength of the blue light is converted into wavelength of yellow light. Yellow light obtained as a result of the wavelength conversion and blue light not reaching the phosphors are mixed together to generate white light, and the white light is emitted from an upper surface of the recess 10a. Light guided by the sealing material 3 is reflected off the bottom wall and the peripheral wall of the recess 10a formed in the package 10, and emitted from the upper surface of the recess 10a. As a result, the light-emitting device 1 emits light over a range corresponding to a size of the recess 10a.

In this case, light incident on the package 10 is reflected at the interface between particles of the glass ceramic 21 and particles of the high refractive index material 23 by the difference in the refractive index therebetween. As a result, reflectance of the package 10 is improved.

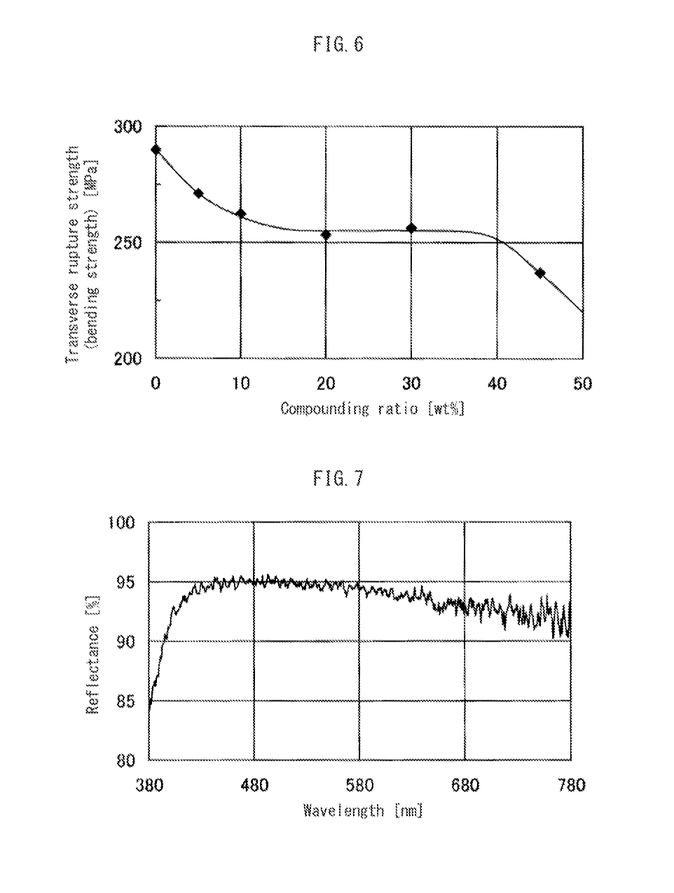

FIG. 5 shows a result of measurement of reflectance (%) of the package 10 by using, as a parameter, a compounding ratio (wt %) of the high refractive index material 23 in the package 10. FIG. 6 shows a result of measurement of transverse rupture strength (bending strength) (MPa) of the package 10 by using, as a parameter, the compounding ratio (wt %) of the high refractive index material 23 in the package 10. In FIGS. 5 and 6, a glass ceramic containing borosilicate glass and alumina is used as the glass ceramic 21, and zircon is used as the high refractive index material 23. In FIG. 5, wavelength as a target of measurement is 450 nm.

According to the results of the measurements, reflectance of the package 10 is increased by increasing the compounding ratio of the high refractive index material 23. Furthermore, transverse rupture strength of the package 10 is increased by decreasing the compounding ratio of the high refractive index material 23.

Presumably, this is because zircon containing silicate ions is more likely to chemically react with glass components within the glass ceramic 21 than zirconia and the like, and is less likely to chemically react with the glass components within the glass ceramic 21 than zinc and the like. As a result, when the compounding ratio of the high refractive index material 23 is low, transverse rupture strength of the package 10 is high, as particles of the high refractive index material 23 chemically react with the glass ceramic 21 surrounding the particles. In this case, reflectance of the package 10 is low because the compounding ratio of the high refractive index material 23 is low.

On the other hand, particles of the high refractive index material 23 agglomerate when the compounding ratio of the high refractive index material 23 is high. As a result, although outer particles chemically react with the glass ceramic 21, chemical reaction of inner particles with the glass components within the glass ceramic 21 is inhibited. Consequently, transverse rupture strength of the package 10 is low, but reflectance of the package 10 is high. Reflectance of the package 10 is improved also due to an increase in the high refractive index material 23.

Accordingly, by selecting the compounding ratio of the high refractive index material 23, the package 10 having desired reflectance and transverse rupture strength can be obtained.

In this case, when the compounding ratio of zircon used as the high refractive index material 23 is 5 wt % or more, the package 10 having a high reflectance of 90% or more can be obtained at a wavelength of 450 nm. When the compounding ratio of zircon is 10 wt % or more, the package 10 having a high reflectance of approximately 94% or more can be obtained at the wavelength of 450 nm. When the compounding ratio of zircon is 20 wt % or more, the package 10 having a high reflectance of approximately 95% or more can be obtained at the wavelength of 450 nm.

When the compounding ratio of zircon is 40 wt % or less, the package 10 having a high transverse rupture strength of approximately 250 MPa or more can be obtained. When the compounding ratio of zircon is 30 wt % or less, the package 10 having a high transverse rupture strength of 250 MPa or more can surely be obtained.

When the high refractive index material 23 is a silicate compound containing silicate ions such as manganese silicate and calcium silicate, reflectance and transverse rupture strength of the package 10 can be increased by selecting the compounding ratio as described above.

FIG. 7 shows a relationship between reflectance (%) of the package 10 and wavelength (nm). A glass ceramic containing borosilicate glass and alumina is used as the glass ceramic 21, and the compounding ratio of the high refractive index material 23 composed of zircon is 20 wt %. Referring to FIG. 7, a high reflectance of approximately 95% can be obtained in a blue light region at around a wavelength of 450 nm, and a high reflectance of 90% or more can be obtained in green and red light regions.

According to the present embodiment, since the package 10 comprises the sintered body that contains the glass ceramic 21 and a silicate compound contained as the high refractive index material 23 in the glass ceramic 21, the package 10 having a high reflectance and strength can be obtained.

Furthermore, since the silicate compound is zircon, the package 10 having a high reflectance and strength can easily obtained.

Furthermore, since the zircon content is 5 wt % or more, the package 10 having a high reflectance of 90% or more can be obtained.

Furthermore, since the zircon content is 10 wt % or more, the package 10 having a high reflectance of approximately 94% or more can be obtained.

Furthermore, since the zircon content is 40 wt % or less, the package 10 having a high transverse rupture strength of 250 MPa or more can be obtained.

### INDUSTRIAL APPLICABILITY

The present invention is applicable to an edge-light type backlight, a light source for a scanner, an LED lamp, and the like each equipped with a light-emitting device including a package for housing a light-emitting element therein.

### REFERENCE SIGNS LIST

1 light-emitting device
2 light-emitting element
3 sealing material
4 wire
10 package
10a recess
12 ceramic sheet
13 terminal
14 heat transfer member
16 heat dissipation member
17 electrode
18 heat dissipation via
19 electrode via
21 glass ceramic
23 high refractive index material

1. A light-emitting device package for housing a light-emitting element therein and reflecting light emitted from the light-emitting element toward a predetermined direction, the light-emitting device package comprising a sintered body that contains: a glass ceramic as a major component; and a high refractive index material having a higher refractive index than the glass ceramic, wherein
the high refractive index material is a silicate compound.

2. The light-emitting device package of claim 1, wherein
the silicate compound is zircon.

3. The light-emitting device package of claim 2, wherein
zircon content is 5 wt % or more.

4. The light-emitting device package of claim 3, wherein
the zircon content is 10 wt % or more.

5. The light-emitting device package of claim 4, wherein
the zircon content is 40 wt % or less.
